(19) United States
(12) Patent Application Publication
(10) Pub. No.: US 2010/0238125 A1
(43) Pub. Date: Sep. 23, 2010

(54) Method, Apparatus, and Computer Program Product For Discontinuous Shapewriting

(75) Inventor: Sami Pekka Ronkainen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/407,966

(22) Filed: Mar. 20, 2009

(51) Int. Cl. G06F 3/041

(52) U.S. Cl. 345/173

(57) ABSTRACT

Various methods for discontinuous shapewriting are provided. One method may include receiving an indication of a first touch event via a touch screen implemented keyboard and receiving an indication of at least a second touch event via the keyboard. In this regard, the first touch event may be discontinuous from the second touch event. The method may also include generating, via a processor, a continuous shape based at least in part on the indication of the first touch event and the indication of the second touch event, and identifying a word based at least in part on the shape. Similar apparatuses and computer program products are also provided.

### TECHNICAL FIELD

Embodiments of the present invention relate generally to data entry on a touch-screen device, and, more particularly, relate to a method, apparatus, and a computer program product for discontinuous shapewriting via a touch screen device.

### BACKGROUND

Advances in display technology have brought about the implementation of touch-screen displays as user interface mechanisms for various types of the electronic devices including mobile communications devices. In particular, touch screen displays have been utilized in cellular telephone applications, as well as tablet personal computer applications. As a part of the user interface of an electronic device, a touch screen display not only provides an output mechanism to the user by displaying images and/or text, but also receives input associated with a user's touching of the screen.

To facilitate user input via a touch screen display, virtual tools, such as the keys of a keyboard, sliders, scroll bars and the like, may be presented on the display to indicate to the user where, and how, to interact with the various tools to implement associated functionalities.

### BRIEF SUMMARY

Methods, apparatuses, and computer program products are described that utilize discontinuous shapewriting to identify a word to be entered by a user. In this regard, various example embodiments of the present invention receive an indication of a first touch event (e.g., a point touch event or a swipe touch event) via a touch screen implemented keyboard. For example, the first touch event may be performed by a user with the user's left-hand thumb and may point touch a letter or swipe across a series of letters. Example embodiments may also receive an indication of at least a second touch event via the keyboard. The second touch event, for example, may be performed by a user with the user's right-hand thumb and may point touch a letter or swipe across a series of letters. Further touch events may be performed in a similar manner. The first touch event may therefore be discontinuous from the second touch event. In this regard, each touch event may be discontinued with respect to any other touch event. In various example embodiments, indications of the first, second, and any additional, touch events may be analyzed to generate a continuous shape based at least in part on the indications of the first and second touch events. According to various example embodiments, the continuous shape may be generated based at least in part on more than two touch events. Using the continuous shape, example embodiments may identify a word that corresponds to the shape by, for example, matching the shape with a predefined shape in a dictionary and retrieving the word associated with the predefined shape. In addition to analyzing the first, second, and any additional touch events to determine a continuous shape, some example embodiments may also identify a start and end location of the touch events, and identify the word based at least in part on the start and end locations of the touch events, possibly in addition to identifying the word based on the generated continuous shape.

Various example embodiments of the present invention are described herein. One example embodiment is a method for discontinuous shapewriting. The example method includes receiving an indication of a first touch event via a touch screen implemented keyboard and receiving an indication of at least a second touch event via the keyboard. In this regard, the first touch event may be discontinuous from the second touch event. The method may also include generating, via a processor, a continuous shape based at least in part on the indication of the first touch event and the indication of the second touch event, and identifying a word based at least in part on the shape.

Another example embodiment is an example apparatus for discontinuous shapewriting. The example apparatus comprises a processor and a memory storing executable instructions that, in response to execution by the processor, cause the example apparatus to perform various functions. The example apparatus is caused to receive an indication of a first touch event via a touch screen implemented keyboard and receive an indication of at least a second touch event via the keyboard. In this regard, the first touch event may be discontinuous from the second touch event. The example apparatus is further caused to generate a continuous shape based at least in part on the indication of the first touch event and the indication of the second touch event and identify a word based at least in part on the shape.

Another example embodiment is an example computer program product for discontinuous shapewriting. The example computer program product comprises at least one computer-readable storage medium having executable computer-readable program code instructions stored therein. The computer-readable program code instructions of the example computer program product are configured to receive an indication of a first touch event via a touch screen implemented keyboard and receive an indication of at least a second touch event via the keyboard. In this regard, the first touch event may be discontinuous from the second touch event. The computer-readable program code instructions of the example computer program product are further configured to generate a continuous shape based at least in part on the indication of the first touch event and the indication of the second touch event and identify a word based at least in part on the shape.

Yet another example embodiment is an apparatus for discontinuous shapewriting. The example apparatus includes means for receiving an indication of a first touch event via a touch screen implemented keyboard and means for receiving an indication of at least a second touch event via the keyboard. In this regard, the first touch event may be discontinuous from the second touch event. The apparatus may also include means for generating a continuous shape based at least in part on the indication of the first touch event and the indication of the second touch event, and means for identifying a word based at least in part on the shape.

### BRIEF DESCRIPTION OF THE DRAWING(S)

Having thus described the invention in general terms, reference will now be made to the accompanying drawings, which are not necessarily drawn to scale, and wherein:

FIG. 1 illustrates an example of a continuous shape for the word “wire” according to various example embodiments of the present invention;

FIG. 2 illustrates an example series of discontinuous touch events and a generated continuous shape for the word “wire” according to various example embodiments of the present invention;

FIG. 3 illustrates an example series of discontinuous touch events and a generated continuous shape for the word “write” according to various example embodiments of the present invention;

FIG. 4 illustrates an example series of discontinuous touch events and a generated continuous shape for the word “wire” on an ITU-T E.161 keypad according to various example embodiments of the present invention;

FIG. 5 is a block diagram of an apparatus for discontinuous shapewriting according to various example embodiments of the present invention; and

FIG. 6 is a flowchart of a method for discontinuous shapewriting according to various example embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, operated on, and/or stored in accordance with embodiments of the present invention. Moreover, the term “exemplary,” as used herein, is not provided to convey any qualitative assessment, but instead to merely convey an illustration of an example.

Interacting with a touch screen display to enter data via, for example a touch screen display implemented keyboard, may involve performing a touch event by a user and receiving indications of the touch event at, for example, a processor. Touch events may be performed by a user contacting a touch screen with a user manipulated physical object such as a stylus, pen, finger, or the like. A touch event may either be a point touch event or a swipe touch event. A point touch event may involve the touching of a single point, or single area, on the touch screen display. An example of a point touch event may be performed by utilizing a user's finger to touch a single key or location on a touch screen implemented keyboard. According to various example embodiments, the layout of the touch screen implemented keyboard is a QWERTY, ISO/IEC 9995-8:1994, ITU-T E.161, numeric (e.g., calculator), or other type of keyboard layout.

A point touch event may have the same start and end location. A swipe touch event may involve a touch, or in some instances a tap, followed by movement while maintaining contact with the touch screen display. A swipe touch event may therefore define a start location and a different end location of the swipe. An example of a swipe touch event may be utilizing a user's finger to touch a first key of a touch screen implemented keyboard (start location) followed by movement to a second and/or third key of the touch screen implemented keyboard, while maintaining continuous contact with the surface of the touch screen display. According to this example, when a final key is moved over, an end location of the example swipe is defined as the location where removal of contact between the touch implement (e.g., the finger) and the surface of the touch screen display occurs.

To enter data into an electronic device via a touch screen display, continuous shapewriting may be utilized. Continuous shapewriting may be implemented as a single swipe touch event where the start location is the first letter of a word and the end location is the last letter of the word. The continuous shapewriting swipe may also include interim movement over each letter that is included in the word to be entered. In contrast, discontinuous shapewriting may involve the creation of a collection of discontinuous touch events, where a continuous shape may be generated based at least in part on attributes of the discontinuous touch events.

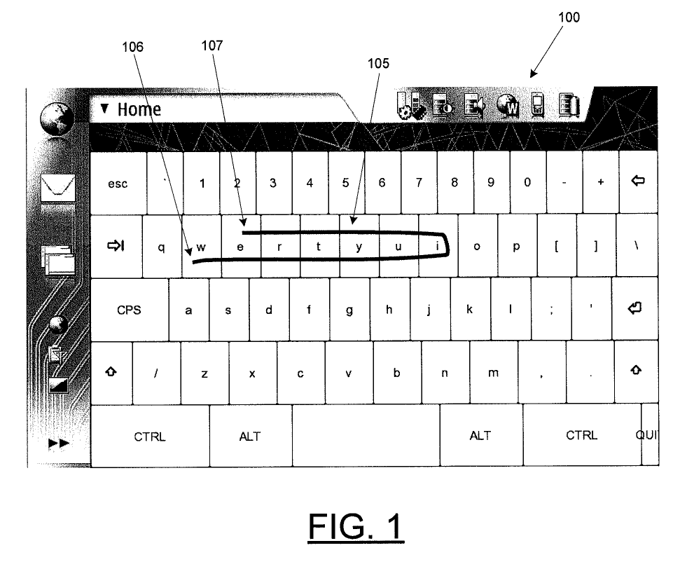

FIG. 1 illustrates an example of a continuous shapewriting swipe 105 on a touch screen implemented or virtual keyboard 100. The continuous shapewriting swipe 105 implements entry of the word “wire.” The continuous shapewriting swipe 105 includes a start location 106 over the letter “w.” The continuous shapewriting swipe 105 subsequently includes movement over the letters “i” and “r,” in addition to movement over other interim letters, and then ends at an end location 107 over the letter “e.”

The track or shape of the continuous shapewriting swipe 105 may be analyzed by a processor in communication with the touch screen display. The analysis may include matching the shape of the continuous shapewriting swipe 105 to a predefined shape in a dictionary. If a match is identified between the shape of the continuous shapewriting swipe 105 and a predefined shape in the dictionary, a word corresponding to the predefined shape may be retrieved and entered into a text field or the like. A shape dictionary may be associated with a particular keyboard layout, such as a QWERTY, ITU-T E.161, ISO/IEC 9995-8:1994, numeric (e.g., calculator), or other type of keyboard layout. One of skill in the art would appreciate that minor variations in a shape generated from a continuous shapewriting swipe may be accounted for in a manner such that the matching process need not identify an exact shape match, but a match may be identified based at least in part on various characteristics of a generated shape that may be common, despite the minor variations.

Continuous shapewriting involves the use of a single implement (e.g., a stylus or finger) to perform data entry. Utilizing two touch implements (e.g., two thumbs) in a continuous shapewriting solution, however, may not be readily supported in a continuous shapewriting scheme, since a continuous swipe event may be difficult to perform with multiple touch implements. In situations where a thumb is to be used as the single touch implement, movement across the entire keyboard may be cumbersome. Further, continuous shapewriting may also have the drawback of multiple words having the same continuous shapes. As such, the analysis of the shape leaves the intended word indeterminate without making assumptions.

For example, referring again to FIG. 1, the word intended to be entered is now “write” rather than “wire.” While these words contain some different letters and different orderings of some letters, note that the continuous shape would be the same for the word “write” as for the word “wire.”

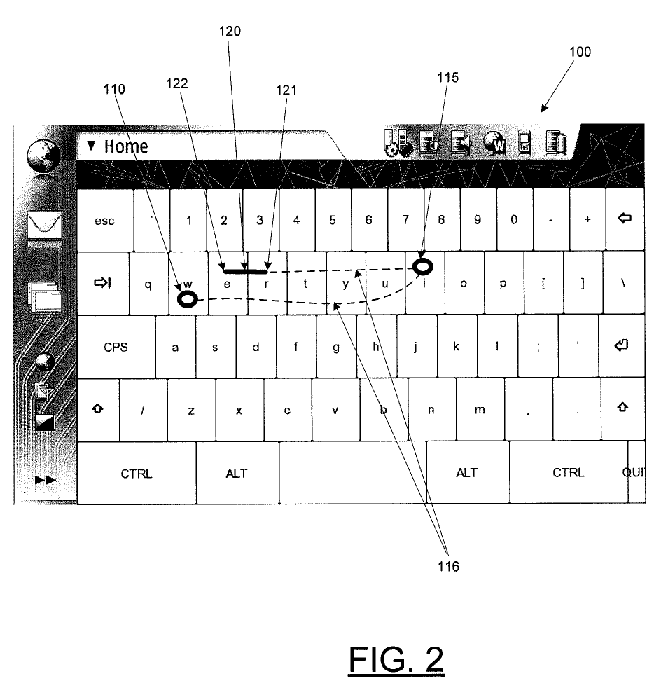

FIG. 2 illustrates an example implementation of discontinuous shapewriting to input the word “wire,” where discontinuous touch events are utilized. In this regard, more than one touch implement (e.g., two thumbs) may be utilized on a touch screen implemented keyboard 100. Example embodiments that provide for at least two touch implements (e.g., two thumbs) facilitate the utilization of touch screen devices in a landscape orientation. The example implementation of FIG. 2 includes three touch events. The first touch event is a point touch event 110 (indicated by the circle) on the key corresponding to the letter “w.” In this regard, the first touch event may be implemented by a left-handed thumb. The second touch event is a point touch event 115 of the key corresponding to the letter “i.” The second touch event may be implemented by a right-handed thumb. The third touch event is a swipe touch event 120 (indicated by the line) beginning at a start location 121 on the key corresponding the letter “r,” and ending at an end location 122 on the key corresponding the letter “e.” The third touch event may be implemented by, again, the left-handed thumb.

The three touch events described in FIG. 2 may be referred to as discontinuous touch events. In this regard, discontinuous touch events may be associated with the entry of a single word, but may be discontinuous in time and space. According to various example embodiments, a processor in communication with the touch screen display of FIG. 2 analyzes the three touch events together. To identify sequences of discontinuous touch events to analyze together to identify a word, various techniques may be used. For example, particular key presses may indicate which touch events should be considered in formulating a word. For example, touch events that occur between touches of the space bar may be grouped together as discontinuous touch events for word analysis. Other keys that may be utilized to identify triggers for grouping discontinuous touch events may include the comma key, the period key, the colon key, the semicolon key, various other punctuation keys, or the like.

Additionally, or alternatively, in some examples embodiments of the present invention, a timer is implemented that triggers or begins when a touch event is completed (e.g., when a finger is removed from contact with the touch screen display). If another touch event begins before the timer reaches a threshold time, then example embodiments of the present invention identify the next touch event as being related to the subsequent touch event, such that the two touch events are associated with the same word. Further, if the timer reaches or exceeds the threshold, example embodiments of the present invention identify the next touch event as being related to a new word, and analysis of the subsequent touch events may be performed to determine the word.

According to various example embodiments, a processor in communication with the touch screen display of FIG. 2 analyzes the locations and sequencing of the touch events that have been identified as being associated with a word. Based at least in part on the start and end locations and sequencing of the identified touch events, the processor may be configured to generate a continuous shape. In some example embodiments, a continuous shape is determined by connecting the end location of a prior touch event with a start location of a subsequent touch event. Referring to FIG. 2, the shape segments 116 illustrate portions of the continuous shape generated by connecting the respective start and end locations of the first, second, and third touch events. The complete continuous shape may be used to determine the word that was intended to be entered by the user. In this regard, the completed continuous shape may be matched to a predefined shape in a dictionary, as described above, to identify a corresponding word for data entry. In the example of FIG. 2, the word “wire” may be entered into a data entry field.

According to some example embodiments, additional information is extracted from the discontinuous touch events to facilitate identifying the desired word. In this regard, example embodiments analyze the first touch event as a point touch event and determine that the letter “w” is the first letter of the word. Since the first touch event is a point touch event, the start location of the next touch event may indicate the next letter in the word. In the example of FIG. 2, the second touch event is another point touch event. As such, the start location and the end location are the same and the next letter of the word may be the letter “i.” Note that although the continuous shape generated based at least in part on the discontinuous touch events moves over various letters (e.g., “e,” “r,” “t”, “y,” and “u”) on the way to “i” from “w,” the moved over letters need not be considered when determining the word since the keys associated with those letters were not interacted with by the user. With respect to the third touch event, which is a swipe, the analysis may determine that the letter corresponding to the key at the start location of the swipe (e.g., the “r” key) and the letter associated with the key at the end location of the swipe (e.g., the “e” key) may also be included in the word.

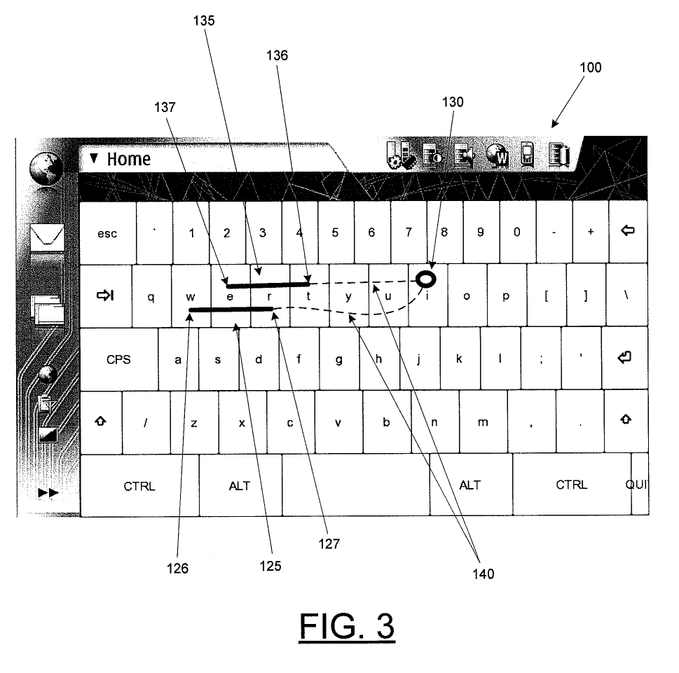

Based at least in part on the discontinuous touch events, the analysis for determining the word “wire” may be distinguished from the analysis of the word “write.” For comparison, FIG. 3 illustrates the discontinuous touch events involved in the generation of the word “write.” Again, more than one touch implement (e.g., two thumbs) may be utilized on a touch screen implemented keyboard 100 of FIG. 3 to generate discontinuous touch events. The example implementation of FIG. 3 includes three touch events. The first touch event is a swipe touch event 125 beginning at a start location 126 on the key corresponding the letter “w,” and ending at an end location 127 on the key corresponding to the letter “r.” In this regard, the first touch event may be implemented by a left-handed thumb. The second touch event is a point touch event 130 of the key corresponding to the letter “i.” The second touch event may be implemented by a right-handed thumb. The third touch event is a swipe touch event 135 beginning at a start location 136 on the key corresponding the letter “t,” and ending at an end location 137 on the key corresponding the letter “e.” The third touch event may be implemented by, again, the left-handed thumb.

While the series of touch events described with respect to FIG. 3 describes one example way of performing touch events to enter the word “write,” it is contemplated that other collections of touch events may be performed that result in an entry of the word “write.” In this regard, a swipe touch event may be shortened and an additional point touch event may be utilized. For example, the third touch event may alternatively be a point touch event for the letter “t” and a point touch event for the letter “e.”

As described above, the first, second, and third touch events of FIG. 3 may be analyzed to generate a continuous shape for identifying a word. Additionally, information may be determined based at least in part on the individual touch events, such as the start and end locations of a swipe touch event, to facilitate further identification of a word. In this regard, while the continuous shape for the words “wire” and “write” may be the same, the information derived for the discontinuous touch events may be distinct. For example, the first touch event for the word “wire” is distinct from the first touch event for the word “write.” The first touch event for the word “wire” is a point touch event indicating that the letter “w” is to be included. However, the first touch event of the word “write” is a swipe touch event indicating that at least the letters “w” followed by the letter “r” are included in the word. Therefore, according to various example embodiments, the distinctions between the discontinuous touch events for an intended word that may have the same continuous shape as another word, can be used to distinguish between the words and more accurately allow for data entry.

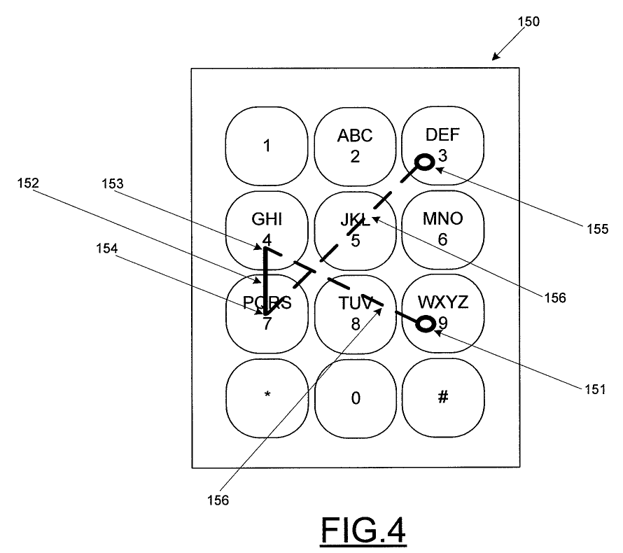

In another example embodiment, discontinuous shapewriting may be utilized with a touch screen implemented ITU-T E.161 (or other ITU-T standard) keypad. FIG. 4 depicts an example implementation of discontinuous shapewriting to input the word “wire” on a touch screen implemented ITU-T E.161 keypad 150. In this regard, a device in communication with the touch screen may be configured to analyze discontinuous touch event to generate a continuous shape. Based on at least the continuous shape, and possibly start and end locations of the touch events, a words may be identified. The device may analyze the touch events with respect to the locations of the keys. An associated dictionary configured to facilitate identification of a word may be assembled with respect to the multiple letters associated with the various keys.

The example implementation of FIG. 4 includes three touch events. The first touch event is a point touch event 151 on the key corresponding to the letter “w”. The second touch event is a swipe touch event 152 beginning at a start location 153 on the key corresponding letter “i,” and ending at an end location 154 on the key corresponding the letter “r.” The third touch event is a point touch event 155 on the key corresponding to the letter “w”. The three touch events may be utilized to generate a continuous shape 156 as described above, and generally herein. Based at least in part on the continuous shape 156 and, possibly the start location 153 and/or the end location 154, a word may be identified.

FIGS. 1-4 illustrate example embodiments of the present invention with respect to English words. However, as used herein the term word may be construed to include any string of characters such as letters, numbers, symbols, or the like. For example, embodiments of the present invention may be utilized to enter a password that includes letters, numbers, and signals. Further, embodiments of the present invention may also be associated with any written language.

Additionally, according to various example embodiments, a prediction engine is also implemented. The prediction engine may generate a preliminary continuous shape upon completion of each touch event. Based on the preliminary continuous shape, and possibly start and/or end locations of the touch events, a candidate word list may be generated. The candidate word list may be displayed to the user, and the touch screen display may be configured to allow for selection of a candidate word, possibly for entry into a data field.

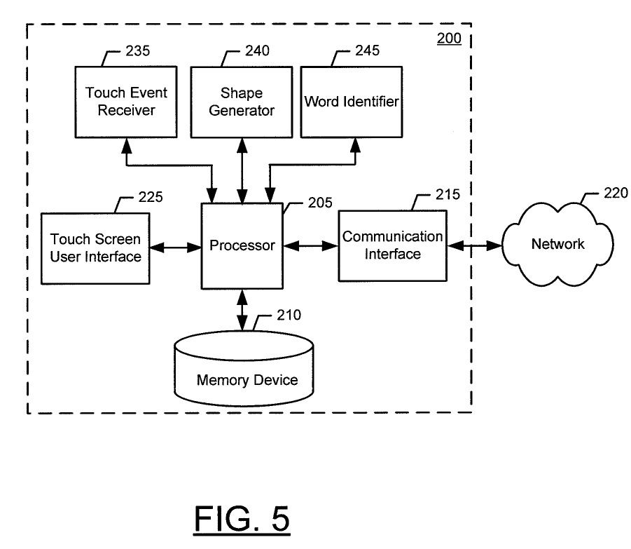

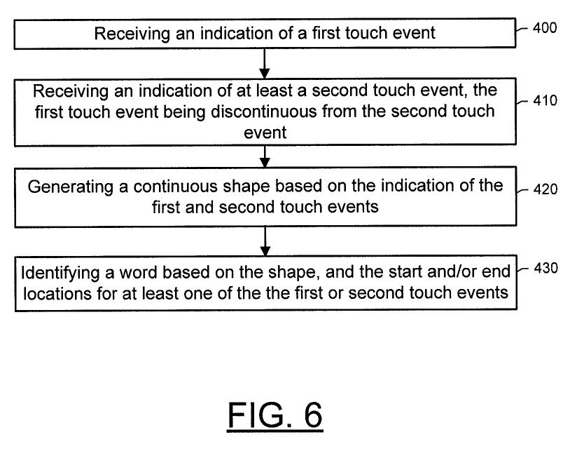

The description provided above and herein illustrates example methods, apparatuses, and computer program products for discontinuous shapewriting. FIG. 5 illustrates another example embodiment of the present invention in the form of an example apparatus 200 that is configured to perform various aspects of the present invention as described herein. The apparatus 200 may be configured to perform example methods of the present invention, such as those described with respect to FIG. 6.

In some example embodiments, the apparatus 200 may, but need not, be embodied as, or included as a component of, a communications device with wired or wireless communications capabilities. Some examples of the apparatus 200, or devices that may include the apparatus 200, may include a computer, a server, a network entity, a mobile terminal such as a mobile telephone, a portable digital assistant (PDA), a pager, a mobile television, a gaming device, a mobile computer, a laptop computer, a camera, a video recorder, an audio/video player, a radio, and/or a global positioning system (GPS) device, or any combination of the aforementioned, or the like. Further, the apparatus 200 may be configured to implement various aspects of the present invention as described herein including, for example, various example methods of the present invention, where the methods may be implemented by means of a hardware configured processor or a processor configured through the execution of instructions stored in a computer-readable storage medium, or the like.

The apparatus 200 may include or otherwise be in communication with a processor 205, a memory device 210, a touch screen user interface 225, a touch event receiver 235, a shape generator 240, and/or a word identifier 245. In some embodiments, the apparatus 200 may optionally include a communications interface 215. The processor 205 may be embodied as various means implementing various functionality of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. In some example embodiments, the processor 205 may, but need not, include one or more accompanying digital signal processors. In some example embodiments, the processor 205 may be configured to execute instructions stored in the memory device 210 or instructions otherwise accessible to the processor 205. As such, whether configured by hardware or via instructions stored on a computer-readable storage medium, or by a combination thereof, the processor 205 may represent an entity capable of performing operations according to embodiments of the present invention while configured accordingly. Thus, for example, when the processor 205 is embodied as an ASIC, FPGA or the like, the processor 205 may be specifically configured hardware for conducting the operations described herein. Alternatively, when the processor 205 is embodied as an executor of instructions stored on a computer-readable storage medium, the instructions may specifically configure the processor 205 to perform the algorithms and operations described herein. However, in some cases, the processor 205 may be a processor of a specific device (e.g., a mobile terminal) configured for employing example embodiments of the present invention by further configuration of the processor 205 via executed instructions for performing the algorithms and operations described herein.

The memory device 210 may be one or more computer-readable storage media that may include volatile and/or non-volatile memory. For example, memory device 210 may include Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, or the like for enabling the processor 205 and the apparatus 200 to carry out various functions in accordance with example embodiments of the present invention. For example, the memory device 210 could be configured to buffer input data for processing by the processor 205. Additionally, or alternatively, the memory device 210 may be configured to store instructions for execution by the processor 205.

The communication interface 215 may be any device or means embodied in either hardware, a computer program product, or a combination of hardware and a computer program product that is configured to receive and/or transmit data from/to a network and/or any other device or module in communication with the apparatus 200. Processor 205 may also be configured to facilitate communications via the communications interface by, for example, controlling hardware included within the communications interface 215. In this regard, the communication interface 215 may include, for example, one or more antennas, a transmitter, a receiver, a transceiver and/or supporting hardware, including a processor for enabling communications with network 220. Via the communication interface 215 and the network 220, the apparatus 200 may communicate with various other network entities in a peer-to-peer fashion or via indirect communications via a base station, access point, server, gateway, router, or the like.

The communications interface 215 may be configured to provide for communications in accordance with any wired or wireless communication standard. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wigbee and/or the like

The touch screen user interface 225 may be in communication with the processor 205 to receive user input via the touch screen user interface 225 and/or to present output to a user as, for example, audible, visual, mechanical or other output indications. The user interface 225 may include, for example, a keyboard, a mouse, a joystick, a touch screen display, a microphone, a speaker, or other input/output mechanisms.

The touch event receiver 235, the shape generator 240, and the word identifier 245 of apparatus 200 may be any means or device embodied, partially or wholly, in hardware, a computer program product, or a combination of hardware and a computer program product, such as processor 205 implementing stored instructions to configure the apparatus 200, or a hardware configured processor 205, that is configured to carry out the functions of the touch event receiver 235, the shape generator 240, and/or the word identifier 245 as described herein. In an example embodiment, the processor 205 includes, or controls, the touch event receiver 235, the shape generator 240, and/or the word identifier 245. The touch event receiver 235, the shape generator 240, and/or the word identifier 245 may be, partially or wholly, embodied as processors similar to, but separate from processor 205. In this regard, touch event receiver 235, the shape generator 240, and/or the word identifier 245 may be in communication with the processor 205. In various example embodiments, the touch event receiver 235, the shape generator 240, and/or the word identifier 245 may, partially or wholly, reside on differing apparatuses such that some or all of the functionality of the touch event receiver 235, the shape generator 240, and/or the word identifier 245 may be performed by a first apparatus, and the remainder of the functionality of the touch event receiver 235, the shape generator 240, and/or the word identifier 245 may be performed by one or more other apparatuses.

The touch event receiver 235 may be configured to receive an indication of a first touch event via a touch screen implementation of a keyboard. The touch event receiver 235 may also be configured to receive an indication of at least a second touch event via the keyboard. In this regard the first touch event may be discontinuous from the second touch event. The touch event receiver may be configured to store locations (e.g., start and end locations) of the touch events, and the sequencing of the touch events. In some example embodiments, the touch event receiver 235 is configured to receive the indications of the first and second touch events as either a swipe across two or more letters of the keyboard or as a point touch event directed to a single letter. Additionally, or alternatively, the touch event receiver 235 may be configured to receive the first and second touch events via a touch screen implemented QWERTY keyboard.

The shape generator 240 may be configured to generate a continuous shape based at least in part on the indication of the first touch event and an indication of at least a second touch event. In some example embodiments, shape generator 240 is configured to identify a start and/or end location for at least one of the first touch event or the second touch events.

The word identifier 245 may be configured to identify a word based at least in part on the generated shape. In some example embodiments, the word identifier 245 may be configured to identify a word based at least in part on a generated continuous shape. In this regard, identifying the word may be performed based at least in part on the shape and a start and/or end location of a touch event. In some example embodiments, the word identifier 245 is also configured to match the shape with a predefined shape in a dictionary and identifying the word associated with the matched shape. The shape dictionary may also include information regarding the start and end points of discontinuous touch events associated with a word for matching. The shape dictionary may be stored on and accessed via the memory device 210. Additionally, or alternatively, the word identifier 245 may be configured to control a touch screen display, such as a touch screen display associated with the user interface 225, to provide for presentation of the word in, for example, a data entry field or document.

FIG. 6 illustrates a flowchart of a system, method, and computer program product according to example embodiments of the invention. It will be understood that each block, step, or operation of the flowchart, and/or combinations of blocks, steps, or operations in the flowchart, can be implemented by various means. Means for implementing the blocks, steps, or operations of the flowchart, combinations of the blocks, steps or operations in the flowchart or other functionality of example embodiments of the invention described herein may include hardware, and/or a computer program product including a computer-readable storage medium having one or more computer program code instructions, program instructions, or executable computer-readable program code instructions store therein. In this regard, program code instructions may be stored on a memory device, such as memory device 210, of an apparatus, such as apparatus 200, and executed by a processor, such as the processor 205. As will be appreciated, any such program code instructions may be loaded onto a computer or other programmable apparatus (e.g., processor 205, memory device 210) from a computer-readable storage medium to produce a particular machine, such that the particular machine becomes a means for implementing the functions specified in the flowchart's block(s), step(s), or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowchart's block(s), step(s), or operation(s). The program code instructions may be retrieved from a computer-readable storage medium and loaded into a computer, processor, or other programmable apparatus to configure the computer, processor, or other programmable apparatus to execute operational steps to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide steps for implementing the functions specified in the flowchart's block(s), step(s), or operation(s).

Accordingly, execution of instructions associated with the blocks, steps, or operations of the flowchart by a processor, or storage of instructions associated with the blocks, steps, or operations of the flowchart in a computer-readable storage medium, support combinations of steps for performing the specified functions. It will also be understood that one or more blocks, steps, or operations of the flowchart, and combinations of blocks, steps, or operations in the flowchart, may be implemented by special purpose hardware-based computer systems and/or processors which perform the specified functions or steps, or combinations of special purpose hardware and program code instructions.

FIG. 6 depicts an example method for discontinuous shapewriting according to various embodiments of the present invention. The example method includes receiving an indication of a first touch event via a touch screen implemented keyboard at 400. The example method also includes receiving an indication of at least a second touch event via the keyboard at 410. In this regard, the first touch event may be discontinuous from the second touch event. In some example embodiments, receiving the indications of the first and second touch events includes receiving the indications of the first and second touch events as swipes from a first key to a second key, or as point touches of a single key. In some example embodiments, receiving the indication of the first or second touch event includes receiving the first touch event via a touch screen implemented QWERTY keyboard.

Further, the example method includes generating, via a processor, a continuous shape based at least in part on the indication of the first touch event and the indication of the second touch event at 420. In some embodiments, the example method also includes identifying a start and end location for at least one of the first touch event or the second touch event. At 430, the example method includes identifying a word based at least in part on the shape. In some example embodiments, identifying the word based at least in part on the shape includes identifying the word based at least in part on the shape, a start location, and/or an end location. In some example embodiments, identifying the word based on the shape includes matching the shape with a predefined shape in a dictionary and identifying the word associated with the matched shape. In some embodiments, the example method also includes providing for presentation of the word on a touch screen display.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1. A method comprising:
receiving an indication of a first touch event via a touch screen implemented keyboard;
receiving an indication of at least a second touch event via the keyboard, the first touch event being discontinuous from the second touch event;
generating, via a processor, a continuous shape based at least in part on the indication of the first touch event and the indication of the second touch event; and
identifying a word based at least in part on the shape.

2. The method of claim 1, further comprising identifying a start or end location for at least one of the first touch event or the second touch event; and wherein identifying the word based at least in part on the shape includes identifying the word based at least in part on the shape and the start or end location.

3. The method of claim 1, wherein receiving the indications of the first and second touch events includes receiving the indications of the first and second touch events, wherein at least one of the first or second touch events comprises a swipe from a first key to a second key.

4. The method of claim 1, wherein receiving the indication of the first touch event includes receiving the first touch event via a touch screen implemented QWERTY, ITU-T, ISO/IEC 9995-8:1994, or numeric keyboard.

5. The method of claim 1, wherein identifying the word based at least in part on the shape includes matching the shape with a predefined shape in a dictionary and identifying the word associated with the matched shape.

6. The method of claim 1, further comprising providing for presentation of the word on a touch screen display.

7. An apparatus comprising a processor and a memory storing executable instructions that, in response to execution by the processor, cause the apparatus to at least:
receive an indication of a first touch event via a touch screen implemented keyboard;
receive an indication of at least a second touch event via the keyboard, the first touch event being discontinuous from the second touch event;
generate a continuous shape based at least in part on the indication of the first touch event and the indication of the second touch event; and
identify a word based at least in part on the shape.

8. The apparatus of claim 7, wherein the executable instructions further cause the apparatus to identify a start or end location for at least one of the first touch event or the second touch event; and wherein the executable instructions that cause the apparatus to identify the word based at least in part on the shape include causing the apparatus to identify the word based at least in part on the shape and the start or end location.

9. The apparatus of claim 7, wherein the executable instructions that cause the apparatus to receive the indications of the first and second touch events include causing the apparatus to receive the indications of the first and second touch events, wherein at least one of the first or second touch events comprises a swipe from a first key to a second key.

10. The apparatus of claim 7, wherein the executable instructions that cause the apparatus to receive the indication of the first touch event include causing the apparatus to receive the first touch event via a touch screen implemented QWERTY, ITU-T, ISO/IEC 9995-8:1994, or numeric keyboard.

11. The apparatus of claim 7, wherein the executable instructions that cause the apparatus to identify the word based at least in part on the shape include causing the apparatus to match the shape with a predefined shape in a dictionary and identify the word associated with the matched shape.

12. The apparatus of claim 7, wherein the executable instructions further cause the apparatus to provide for presentation of the word on a touch screen display.

13. The apparatus of claim 7, wherein the apparatus comprises a mobile terminal.

14. A computer program product comprising at least one computer-readable storage medium having executable computer-readable program code instructions stored therein, the computer-readable program code instructions configured to:
receive an indication of a first touch event via a touch screen implemented keyboard;
receive an indication of at least a second touch event via the keyboard, the first touch event being discontinuous from the second touch event;
generate a continuous shape based at least in part on the indication of the first touch event and the indication of the second touch event; and
identify a word based at least in part on the shape.

15. The computer program product of claim 14, wherein the computer-readable program code instructions are further configured to identify a start or end location for at least one of the first touch event or the second touch event; and wherein the computer-readable program code instructions configured to identify the word based at least in part on the shape include being configured to identify the word based at least in part on the shape and the start or end location.

16. The computer program product of claim 14, wherein the computer-readable program code instructions configured to receive the indications of the first and second touch events include being configured to receive the indications of the first and second touch events, wherein at least one of the first or second touch events comprises a swipe from a first key to a second key.

17. The computer program product of claim 14, wherein the computer-readable program code instructions configured to receive the indication of the first touch event include being configured to cause the apparatus to receive the first touch event via a touch screen implemented QWERTY, ITU-T, ISO/IEC 9995-8:1994, or numeric keyboard.

18. The computer program product of claim 14, wherein the computer-readable program code instructions configured to identify the word based at least in part on the shape include being configured to match the shape with a predefined shape in a dictionary and identify the word associated with the matched shape.

19.-20. (canceled)
